(19) United States
(12) Patent Application Publication
(10) Pub. No.: US 2012/0243731 A1
(43) Pub. Date: Sep. 27, 2012

(54) IMAGE PROCESSING METHOD AND IMAGE PROCESSING APPARATUS FOR DETECTING AN OBJECT

(76) Inventor: Chen-Leh Wang, Taipei (TW)

(21) Appl. No.: 13/071,529

(22) Filed: Mar. 25, 2011

(51) Int. Cl. G06K 9/00

(52) U.S. Cl. 382/103

(57) ABSTRACT

An image processing method and an image processing apparatus for detecting an object are provided. The image processing method includes the following steps: partitioning an image into at least a first sub-image covering a first zone and a second sub-image covering a second zone according to a designed trait; and performing an image detection process upon the first sub-image for checking whether the object is within the first zone to generate a first detecting result. The object is a human face, and the image detection process is a face detection process.

### BACKGROUND

The present disclosure relates to detecting an object in an image, and more particularly, to an image processing method and related image processing apparatus for performing a face detection process.

For an image processing apparatus, such as a television equipped with an image capturing device such as a camera, a face detection function is usually completed by performing a face detection process upon a whole image captured by the camera. However, the processing speed is too slow if face detection process is performed upon the whole image. For this reason, the image can be re-sampled down and resized into a smaller image in order to improve the processing speed/efficiency of the face detection process. However, the re-sampled down image may cause failure in face recognition.

Hence, how to improve the performance of the image processing apparatus has become an important issue to be solved by designers in this field.

### SUMMARY

It is therefore one of the objectives of the present disclosure to provide an image processing method and related image processing apparatus for detecting an object to solve the above-mentioned problems.

According to one aspect of the present disclosure, an exemplary image processing method for detecting an object is provided. The exemplary method includes the following steps: partitioning an image into at least a first sub-image covering a first zone and a second sub-image covering a second zone according to a designed trait; and performing an image detection process upon the first sub-image for checking whether the object is within the first zone to generate a first detecting result. The object may be a human face, and the image detection process may be a face detection process.

According to another aspect of the present disclosure, an exemplary image processing apparatus for detecting an object is provided. The exemplary image processing apparatus includes an image partitioning module and an image detecting module. The image partitioning module may be arranged to partition an image into at least a first sub-image covering a first zone and a second sub-image covering a second zone according to a designed trait. The image detecting module may be arranged to perform an image detection process upon the first sub-image for checking whether the object is within the first zone to generate a first detecting result. The image processing apparatus may be a television.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an architecture of an image processing apparatus for detecting an object according to a first embodiment of the present disclosure.

FIG. 2 is a diagram showing an image.

FIG. 3 is a block diagram illustrating an architecture of an image processing apparatus for detecting an object according to a second embodiment of the present disclosure.

FIG. 4 is a block diagram illustrating an architecture of an image processing apparatus for detecting an object according to a third embodiment of the present disclosure.

FIG. 5 is a block diagram illustrating an architecture of an image processing apparatus for detecting an object according to a forth embodiment of the present disclosure.

FIG. 6 is a flowchart illustrating an image processing method for detecting an object according to an exemplary embodiment of the present disclosure.

FIG. 7 is a flowchart illustrating an image processing method for detecting an object according to another exemplary embodiment of the present disclosure.

FIG. 8 is a flowchart illustrating an image processing method for detecting an object according to another exemplary embodiment of the present disclosure.

FIG. 9 is a flowchart illustrating an image processing method for detecting an object according to still another exemplary embodiment of the present disclosure.

FIG. 10 (including 10A and 10B) is a diagram illustrating an embodiment of the scanning window SW1 shown in FIG. 4.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

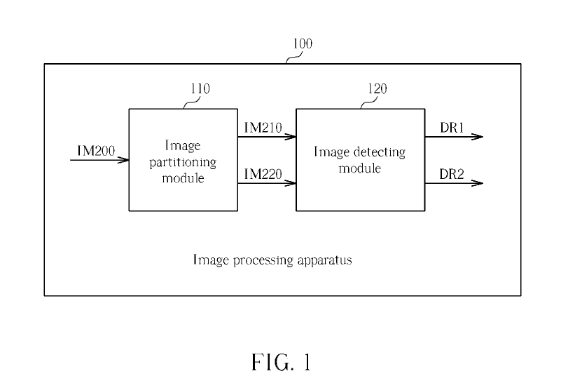

FIG. 1 is a block diagram illustrating an architecture of an image processing apparatus 100 for detecting an object according to a first embodiment of the present disclosure. As shown in the figure, the image processing apparatus 100 includes, but is not limited to, an image partitioning module 110 and an image detecting module 120. The image partitioning module 110 is arranged to partition an image into at least a first sub-image covering a first zone and a second sub-image covering a second zone according to a designed trait. The image detecting module 120 is arranged to perform an image detection process upon the first sub-image for checking whether the object is within the first zone and accordingly generating a first detecting result DR1. Be noted that when the first detecting result DR1 of the image detecting module 120 indicates that the object is not detected within the first zone, the image detecting module 120 may be further arranged to perform the image detection process upon the whole image for checking whether the object is detected within the first zone and the second zone and accordingly generating a second detecting result DR2.

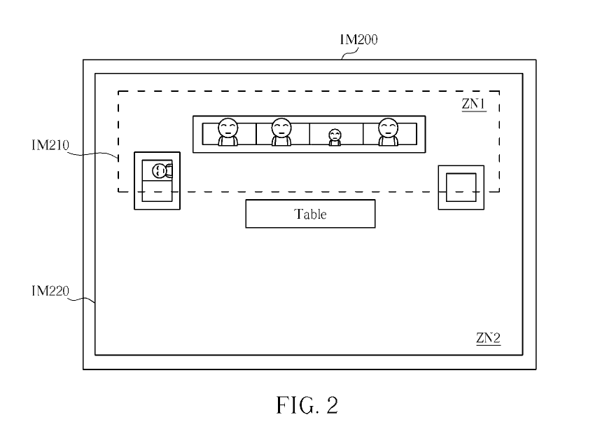

Please refer to FIG. 2, which is a diagram showing an image IM200 which may be captured by a camera (not shown) of the image processing apparatus 100. In this embodiment, the image IM200 is partitioned into a first sub-image IM210 and a second sub-image IM220 by the image partitioning module 110 according to a designed trait, wherein the first sub-image IM210 covers a first zone ZN1 and the second sub-image IM220 covers a second zone ZN2. Please note that, in one embodiment, the object to be detected may be a human face, the image detection process may be a face detection process, and the image detecting module 120 may be implemented by a face detecting module. However, this is for illustrative purposes only, and is not meant to be limitations of the present disclosure.

Furthermore, the image processing apparatus 100 may be implemented by a television, but the present disclosure is not limited to this only. In this embodiment, the first zone ZN1 can also be called as a hot-zone. As one can see, the first zone ZN1 (i.e., the hot-zone) represents a particular region where audiences may stay there frequently. Because the television is usually located in the living room, and furniture layout (e.g., an area including a table and a sofa) is usually fixed and historical detected face position is almost in a particular region such as the first zone ZN1, we can perform the image detection process upon the first sub-image IM210 first for checking whether the object (e.g., the human face) is within the first zone ZN1 (i.e., the hot-zone) to generate the first detecting result DR1. Therefore, processing speed and success rate of the image detection process (e.g., the face detection process) can be improved greatly.

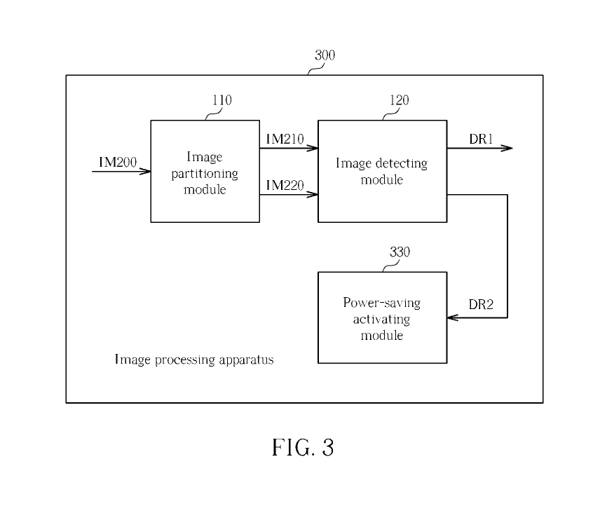

FIG. 3 is a block diagram illustrating an architecture of an image processing apparatus 300 for detecting an object according to a second embodiment of the present disclosure. As shown in the figure, the image processing apparatus 300 includes, but is not limited to, the aforementioned image partitioning module 110 and image detecting module 120, and a power-saving activating module 330. The architecture of the image processing apparatus 300 shown in FIG. 3 is similar to that of the image processing apparatus 100 shown in FIG. 1, and the major difference between them is that the image processing apparatus 300 further includes the power-saving activating module 330. In this embodiment, the power-saving activating module 330 is arranged to activate a power-saving mode, for example, for turning off the television when the second detecting result DR2 of the image detecting module 120 indicates that the object is not detected within the first zone ZN1 and the second zone ZN2. Therefore, when there is no person/viewer standing or sitting in front of an application device (e.g., a television) which provides the image analyzed by the image processing apparatus 300 (i.e., when there is no human face detected within the first zone ZN1 and the second zone ZN2), a goal of saving power can be achieved with the help of the image processing apparatus 300.

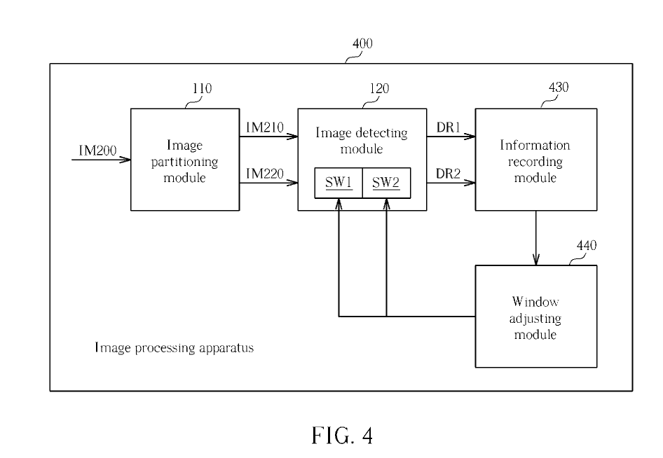

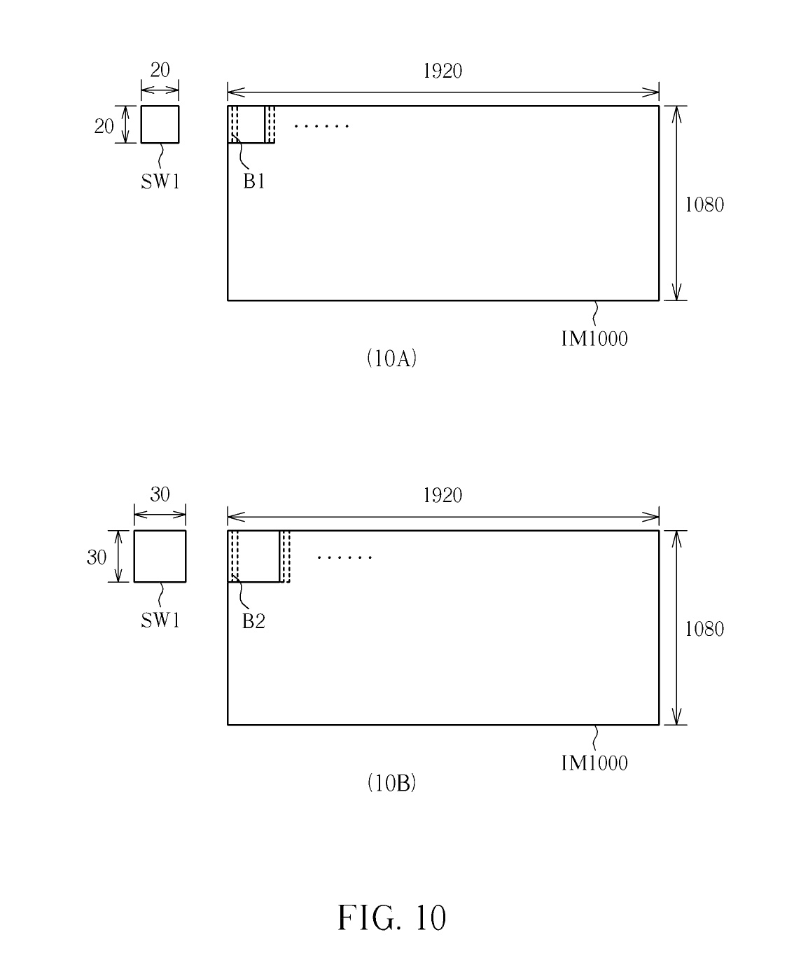

FIG. 4 is a block diagram illustrating an architecture of an image processing apparatus 400 for detecting an object according to a third embodiment of the present disclosure. As shown in the figure, the image processing apparatus 400 includes, but is not limited to, the aforementioned image partitioning module 110 and image detecting module 120, an information recording module 430, and a window adjusting module 440. The architecture of the image processing apparatus 400 shown in FIG. 4 is similar to that of the image processing apparatus 100 shown in FIG. 1, and the major difference between them is that the image processing apparatus 400 further includes the information recording module 430 and the window adjusting module 440. In one exemplary implementation, the image detecting module 120 may utilize a scanning window SW1 to perform the image detection process for checking whether the object (e.g., the human face) is within the first zone ZN1. Please note that: the scanning window SW1 indicates that a minimum scanning unit to be processed every time. Please refer to FIG. 10. FIG. 10 (including 10A and 10B) is a diagram illustrating an embodiment of the scanning window SW1 shown in FIG. 4. For example, an image IM1000 with a resolution 1920×1080 may totally have 1920×1080 pixels. If we utilize a scanning window SW1 with a size equaling 20×20 pixels to perform the image detection process on this image, each block B1 having 20×20 pixels will be processed by utilizing the scanning window SW1 with the size equaling 20×20 pixels at one time, as is shown in 10A. Next time, the scanning window SW1 will be moved right for a pixel or several pixels, such that a next block having 20×20 pixels next to the current block will be processed by utilizing the scanning window SW with the size equaling 20×20 pixels. If we utilize a scanning window SW1 with a size equaling 30×30 pixels to perform the image detection process on this image IM1000, each block B2 having 30×30 pixels will be processed by utilizing the scanning window SW1 with the size equaling 30×30 pixels at one time, as is shown in 10B. Next time, the scanning window SW1 will be moved right for a pixel or several pixels, such that a next block having 30×30 pixels next to the current block will be processed by utilizing the scanning window SW with the size equaling 30×30 . At this moment, the information recording module 430 may be arranged to record information related to the object as historical data when the first detecting result DR1 of the image detecting module 120 indicates that the object is detected within the first zone ZN1. The window adjusting module 440 may be arranged to update the scanning window SW1 of the image detection process according to the historical data (i.e., the recorded information related to the object). For example, the window adjusting module 440 may adjust the size (such as, the height H or the width W) of the scanning window SW1) based on historical data (i.e., the recorded information related to the face). Furthermore, those skilled in the art should appreciate that: the size (such as, the height H and the weight W) of the first zone ZN1 (i.e., the hot-zone) is not limited in the present disclosure. In one embodiment, the size of the first zone ZN1 can be adjusted according to historical data, as well.

In another exemplary implementation, the image detecting module 120 may utilize a scanning window SW2 to perform the image detection process for checking whether the object (e.g., the human face) is within the first zone ZN1 and the second zone ZN2. At this moment, the information recording module 430 may be arranged to record information related to the object when the second detecting result DR2 of the image detecting module 120 indicates that the object is detected within the first zone ZN1 and the second zone ZN2. The window adjusting module 440 may be arranged to update (or adjust) the scanning window SW2 of the image detection process according to historical data (i.e., the recorded information related to the object).

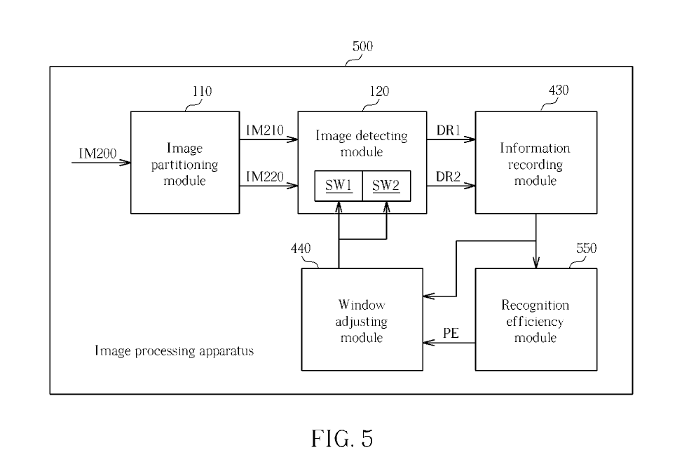

FIG. 5 is a block diagram illustrating an architecture of an image processing apparatus 500 for detecting an object according to a forth embodiment of the present disclosure. As shown in the figure, the image processing apparatus 500 includes, but is not limited to, the aforementioned image partitioning module 110, image detecting module 120, information recording module 430 and window adjusting module 440, and a recognition efficiency module 550. The architecture of the image processing apparatus 500 shown in FIG. 5 is similar to that of the image processing apparatus 400 shown in FIG. 4, and the major difference between them is that the image processing apparatus 500 further includes the recognition efficiency module 550. In this embodiment, the recognition efficiency module 550 may be arranged to obtain a recognition efficiency RE according to the recorded information related to the object. The window adjusting module 440 may be further arranged to adjust the scanning window SW1 or SW2 according to the recognition efficiency RE. For example, a scanning window with a fixed size of 24×24 pixels is usually adopted for face detection process. If historical data (the recorded information related to the object, such as, the size, the number, and the position of the human face) can be used for obtaining the recognition efficiency RE, the scanning window SW1 or SW2 may be adaptively adjusted or optimized according to the recognition efficiency RE in order to improve the processing speed of the face detection. By way of example, but not limitation, the scanning window SW1 or SW2 may be adjusted to employ a size of 30×30 pixels or 20×20 pixels that is different from the original/default size.

Regarding the computation of the recognition efficiency RE, the historical information may be referred to by the recognition efficiency module 550. In one exemplary implementation, the historical maximum value of the detected face size may be used for obtaining the recognition efficiency RE. In another exemplary implementation, the historical minimum value or average value of the detected face size may be used for obtaining the recognition efficiency RE.

As one can know from above paragraphs, since the television is usually located in a fixed location, and furniture layout is usually fixed and historical detected face position is almost in a particular region such as the first zone ZN1 (i.e., the hot zone), we can perform the image detection process upon the first sub-image IM210 first for checking whether the object is within the first zone ZN1 and accordingly generating the first detecting result DR1. Therefore, processing speed and success rate of the image detection process (the face detection process) can be improved. In addition, the scanning window SW1 or SW2 can be adaptively adjusted or optimized according to historical data (i.e., the recorded information related to the object) and/or the recognition efficiency RE in order to improve the processing speed/efficiency of the face detection. Furthermore, those skilled in the art should appreciate that: the size (such as, the height H and the weight W) of the first zone ZN1 (i.e., the hot-zone) can be adjusted according to historical data and/or the recognition efficiency RE, as well.

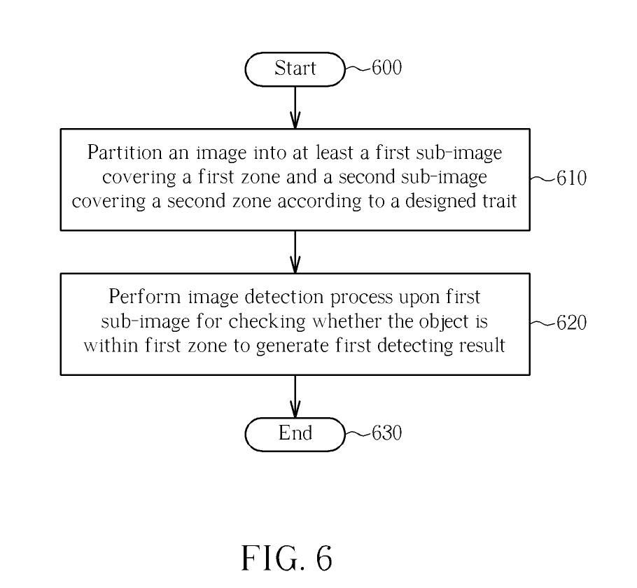

FIG. 6 is a flowchart illustrating an image processing method for detecting an object according to an exemplary embodiment of the present disclosure. Please note that the steps are not required to be executed in the exact order shown in FIG. 6, provided that the result is substantially the same. The generalized image processing method may be briefly summarized by following steps:

Step 600: Start.

Step 610: Partition an image into at least a first sub-image covering a first zone and a second sub-image covering a second zone according to a designed trait.

Step 620: Perform an image detection process upon the first sub-image for checking whether an object (e.g., a human face) is within the first zone to generate a first detecting result.

Step 630: End.

As a person skilled in the art can readily understand details of the steps in FIG. 6 after reading above paragraphs directed to the image processing apparatuses 100 shown in FIG. 1, further description is omitted here for brevity. Please note that, the step 610 may be executed by the image partitioning module 110, and the step 620 may be executed by the image detecting module 120.

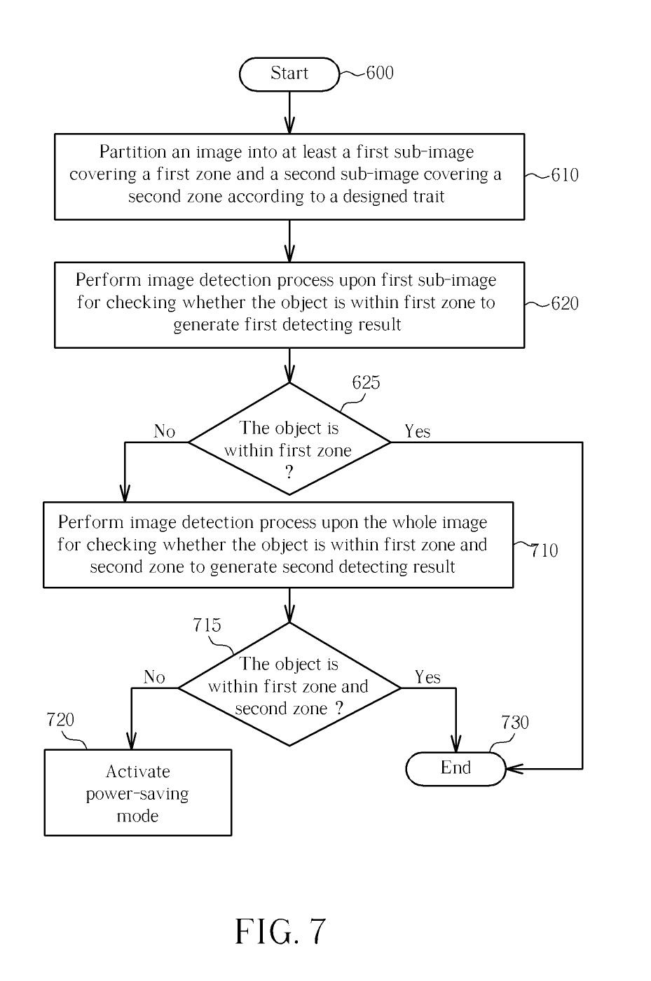

FIG. 7 is a flowchart illustrating an image processing method for detecting an object according to another exemplary embodiment of the present disclosure. The exemplary image processing method includes, but is not limited to, the following steps:

Step 600: Start.

Step 610: Partition an image into at least a first sub-image covering a first zone and a second sub-image covering a second zone according to a designed trait.

Step 620: Perform an image detection process upon the first sub-image for checking whether an object (e.g., a human face) is within the first zone (i.e., the hot-zone) to generate a first detecting result.

Step 625: Check if the object is detected within the first zone. When the first detecting result indicates that the object is not detected within the first zone, go to step 710; otherwise, go to step 730.

Step 710: Perform the image detection process upon the whole image for checking whether the object is within the first zone and the second zone to generate a second detecting result.

Step 715: Check if the object is detected within the first zone and the second zone. When the second detecting result indicates that the object is not detected within the first zone and the second zone, go to step 720; otherwise, go to step 730.

Step 720: Activate a power-saving mode.

Step 730: End.

As a person skilled in the art can readily understand details of the steps in FIG. 7 after reading above paragraphs directed to the image processing apparatuses 300 shown in FIG. 3, further description is omitted here for brevity. Please note that, the step 710 may be executed by the image detecting module 120, and the step S720 may be executed by the power-saving activating module 330.

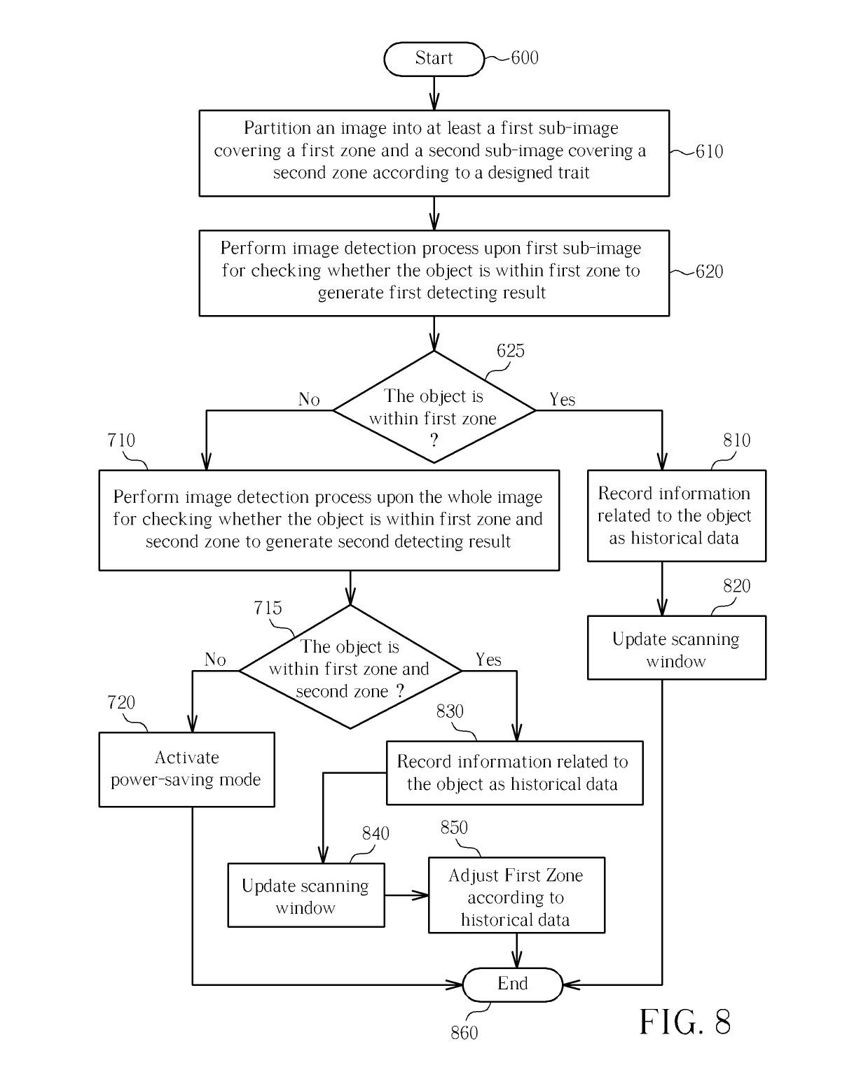

FIG. 8 is a flowchart illustrating an image processing method for detecting an object according to another exemplary embodiment of the present disclosure. The exemplary image processing method includes, but is not limited to, the following steps:

Step 600: Start.

Step 610: Partition an image into at least a first sub-image covering a first zone and a second sub-image covering a second zone according to a designed trait.

Step 620: Perform an image detection process upon the first sub-image for checking whether an object (e.g., a human face) is within the first zone (i.e., the hot-zone) to generate a first detecting result.

Step 625: Check if the object is detected within the first zone. When the first detecting result indicates that the object is not detected within the first zone, go to step 710. Otherwise, go to step 810.

Step 810: Record information related to the object as historical data.

Step 820: Update the scanning window of the image detection process according to the historical data with the recorded information related to the object.

Step 710: Perform the image detection process upon the whole image for checking whether the object is within the first zone and the second zone to generate a second detecting result.

Step 715: Check if the object is detected within the first zone and the second zone. When the second detecting result indicates that the object is not detected within the first zone and the second zone, go to step 720. Otherwise, go to step 830.

Step 720: Activate a power-saving mode.

Step 830: Record information related to the object as historical data.

Step 840: Update the scanning window of the image detection process according to the historical data with the recorded information related to the object.

Step 850: Adjust the size of the first zone (i.e., the hot-zone) according to the historical data with the recorded information related to the object.

Step 860: End.

As a person skilled in the art can readily understand the details of the steps in FIG. 8 after reading above paragraphs directed to the image processing apparatuses 400 shown in FIG. 4, further description is omitted here for brevity. Please note that, the steps 810 and 830 may be executed by the information recording module 430, the steps 820 and 840 may be executed by the window adjusting module 440, and the step 850 may be executed by the image partitioning module 110.

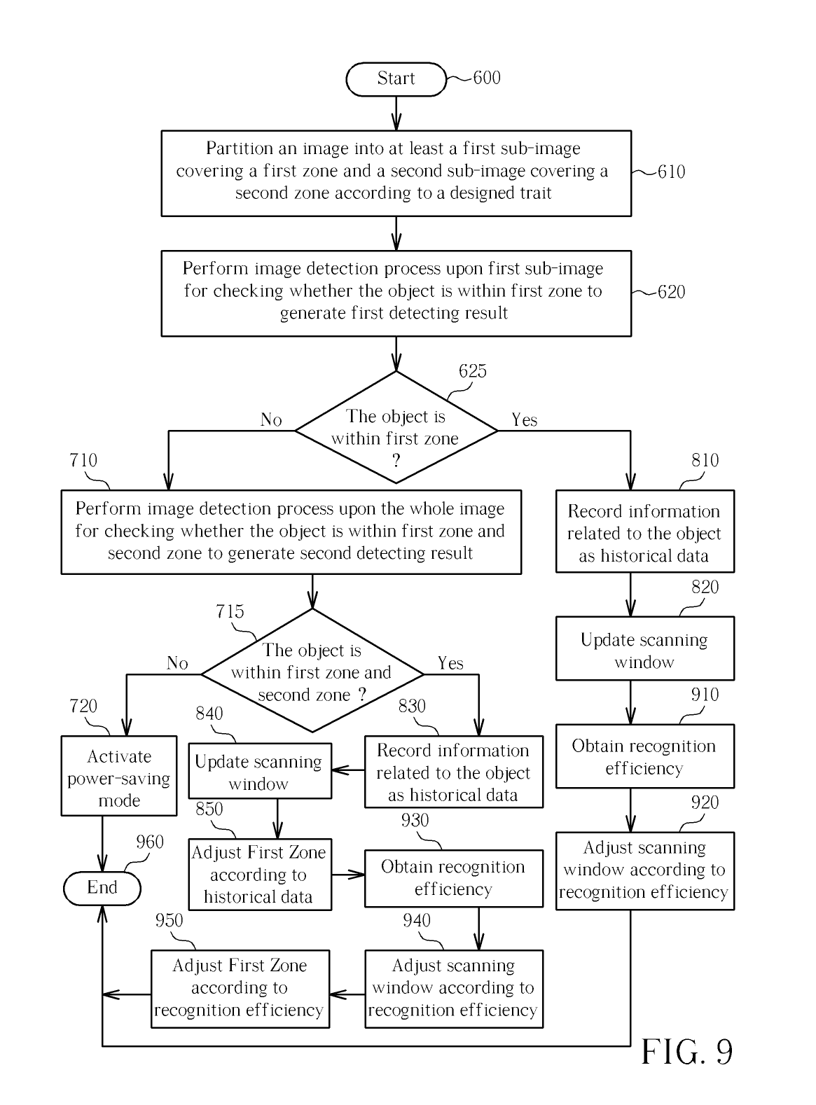

FIG. 9 is a flowchart illustrating an image processing method for detecting an object according to still another exemplary embodiment of the present disclosure. The exemplary image processing method includes, but is not limited to, the following steps:

Step 600: Start.

Step 610: Partition an image into at least a first sub-image covering a first zone and a second sub-image covering a second zone according to a designed trait.

Step 620: Perform an image detection process upon the first sub-image for checking whether an object (e.g., a human face) is within the first zone (i.e., the hot-zone) to generate a first detecting result.

Step 625: Check if the object is detected within the first zone. When the first detecting result indicates that the object is not detected within the first zone, go to step 710. Otherwise, go to step 810.

Step 810: Record information related to the object as historical data.

Step 820: Update the scanning window of the image detection process according to the historical data with the recorded information related to the object.

Step 910: Obtain a recognition efficiency according to the historical data with the recorded information related to the object.

Step 920: Adjust the scanning window according to the recognition efficiency.

Step 710: Perform the image detection process upon the whole image for checking whether the object is within the first zone and the second zone to generate a second detecting result.

Step 715: Check if the object is detected within the first zone and the second zone. When the second detecting result indicates that the object is not detected within the first zone and the second zone, go to step 720. Otherwise, go to step 830.

Step 720: Activate a power-saving mode.

Step 830: Record information related to the object as historical data.

Step 840: Update the scanning window of the image detection process according to the historical data with the recorded information related to the object.

Step 850: Adjust the size of the first zone (i.e., the hot-zone) according to historical data with the recorded information related to the object.

Step 930: Obtain a recognition efficiency according to the recorded information related to the object.

Step 940: Adjust the scanning window according to the recognition efficiency.

Step 950: Adjust the size of the first zone (i.e., the hot-zone) according to the recognition efficiency.

Step 960: End.

As a person skilled in the art can readily understand the details of the steps in FIG. 9 after reading above paragraphs directed to the image processing apparatuses 500 shown in FIG. 5, further description is omitted here for brevity. Please note that, the steps 910 and 930 may be executed by the recognition efficiency module 550, the steps 920 and 940 may be executed by the window adjusting module 440, and the steps 850 and 950 may be executed by the image partitioning module 110.

The above-mentioned embodiments are presented merely for describing features of the present disclosure, and in no way should be considered to be limitations of the scope of the present disclosure. In summary, the present disclosure provides an image processing method and an image processing apparatus for detecting an object. By performing the image detection process upon the first sub-image covering the first zone (such as, the table and the sofa area in the living room), processing speed and success rate of the image detection process (the face detection process) can be improved greatly. Furthermore, historical detection information can be recorded in order to improve the processing speed and success rate of the image detection process. In addition, the scanning window can be adjusted or optimized according to the recorded information related to the object and/or the recognition efficiency in order to further improve the processing speed/efficiency of the face detection.

Those skilled in the art will readily observe that numerous modifications and alterations of the device and method may be made while retaining the teachings of the invention.

What is claimed is:

1. An image processing method for detecting an object, comprising:
partitioning an image into at least a first sub-image covering a first zone and a second sub-image covering a second zone according to a designed trait; and
performing an image detection process upon the first sub-image for checking whether the object is within the first zone to generate a first detecting result.

2. The image processing method of claim 1, wherein the object is a human face, and the image detection process is a face detection process.

3. The image processing method of claim 1, further comprising:
when the first detecting result indicates that the object is not detected within the first zone, performing the image detection process upon the whole image for checking whether the object is within the first zone and the second zone to generate a second detecting result.

4. The image processing method of claim 3, further comprising:
when the second detecting result indicates that the object is not detected within the first zone and the second zone, activating a power-saving mode.

5. The image processing method of claim 3, wherein the image detection process utilizes a scanning window for checking whether the object is within the first zone and the second zone, and the image processing method further comprises:
when the second detecting result indicates that the object is detected within the first zone and the second zone, recording information related to the object as historical data; and
updating the scanning window of the image detection process according to the historical data with the recorded information related to the object.

6. The image processing method of claim 5, wherein the steps of updating the scanning window of the image detection process comprises:
obtaining a recognition efficiency according to the historical data with the recorded information related to the object; and
adjusting the scanning window according to the recognition efficiency.

7. The image processing method of claim 6, further comprising:
adjusting a size of the first zone according to at least one of the historical data with the recorded information related to the object and the recognition efficiency.

8. The image processing method of claim 1, wherein the image detection process utilizes a scanning window for checking whether the object is within the first zone, and the image processing method further comprises:
when the first detecting result indicates that the object is detected within the first zone, recording information related to the object as historical data; and
updating the scanning window of the image detection process according to the historical data with the recorded information related to the object.

9. The image processing method of claim 8, wherein the step of updating the scanning window of the image detection process comprises:
obtaining a recognition efficiency according to the historical data with the recorded information related to the object; and
adjusting the scanning window according to the recognition efficiency.

10. The image processing method of claim 8, further comprising:
adjusting a size of the first zone according to at least one of the historical data with the recorded information related to the object and the recognition efficiency.

11. An image processing apparatus for detecting an object, comprising:
an image partitioning module, arranged to partition an image into at least a first sub-image covering a first zone and a second sub-image covering a second zone according to a designed trait; and
an image detecting module, arranged to perform an image detection process upon the first sub-image for checking whether the object is within the first zone to generate a first detecting result.

12. The image processing apparatus of claim 11, wherein the object is a human face, the image detection process is a face detection process, and the image detecting module is a face detecting module.

13. The image processing apparatus of claim 11, wherein when the first detecting result of the image detecting module indicates that the object is not detected within the first zone, the image detecting module is further arranged to perform the image detection process upon the whole image for checking whether the object is detected within the first zone and the second zone to generate a second detecting result.

14. The image processing apparatus of claim 13, further comprising:
a power-saving activating module, arranged to activate a power-saving mode when the second detecting result indicates that the object is not detected within the first zone and the second zone.

15. The image processing apparatus of claim 13, wherein the image detecting module utilizes a scanning window to perform the image detection process for checking whether the object is within the first zone and the second zone; and the image processing apparatus further comprises:
an information recording module, arranged to record information related to the object as historical data when the second detecting result of the image detecting module indicates that the object is detected within the first zone and the second zone; and
a window adjusting module, arranged to update the scanning window of the image detection process according to the historical data with the recorded information related to the object.

16. The image processing apparatus of claim 15, further comprising:
a recognition efficiency module, arranged to obtain a recognition efficiency according to the historical data with the recorded information related to the object;
wherein the window adjusting module is further arranged to adjust the scanning window according to the recognition efficiency.

17. The image processing apparatus of claim 16, wherein the image partitioning module is further arranged to adjust a size of the first zone according to at least one of the historical data with the recorded information related to the object and the recognition efficiency.

18. The image processing apparatus of claim 11, wherein the image detecting module utilizes a scanning window to perform the image detection process for checking whether the object is within the first zone, and the image processing apparatus further comprises:
an information recording module, arranged to record information related to the object as historical data when the first detecting result of the image detecting module indicates that the object is detected within the first zone; and
a window adjusting module, arranged to update the scanning window of the image detection process according to the historical data with the recorded information related to the object.

19. The image processing apparatus of claim 18, further comprising:
a recognition efficiency module, arranged to obtain a recognition efficiency according to the recorded information related to the object;
wherein the window adjusting module is further arranged to adjust the scanning window according to the recognition efficiency.

20. The image processing apparatus of claim 19, wherein the image partitioning module is further arranged to adjust a size of the first zone according to at least one of the historical data with the recorded information related to the object and the recognition efficiency.

21. The image processing apparatus of claim 11, wherein the image processing apparatus is a television.
